(19) United States
(12) Patent Application Publication
(10) Pub. No.: US 2013/0212187 A1
(43) Pub. Date: Aug. 15, 2013

(54) Mail Management

(71) Applicants: Sean Shahrokh Mortazavi, (US); Brendan Ribera, (US)

(72) Inventors: Sean Shahrokh Mortazavi, (US); Brendan Ribera, (US)

(21) Appl. No.: 13/371,505

(22) Filed: Feb. 13, 2012

(51) Int. Cl. G06F 15/16

(52) U.S. Cl. 709/206

(57) ABSTRACT

The instant application discloses, among other things, techniques to allow a user to inform direct mail senders of their preferences with respect to communications.

### FIELD

This disclosure relates to managing mail.

### BACKGROUND

Paper mail is often sent to people who do not wish to receive it. This mail may be called by various names, including advertising mail, direct mail, junk mail, or admail. The US Postal Service delivers much of this mail, but some companies also use their own distribution systems.

Advertisers often use direct mail campaigns to attract more business; telephone book publishers may use broad distribution to increase their advertising rates. Catalogs, fliers, invitations to sales events, and credit card offers often makes up a majority of the mail an individual receives.

While some of this mail may be desired by a receiver, much of it is discarded without even being reviewed. This is a waste of resources because of the paper used, and a waste of money for the sender since they are spending money to print and mail items that may simply make the receiver annoyed with the sender.

In other cases, people may be interested in receiving more mail from a particular company, or they may wish to receive information and coupons and other communication from a sender electronically or via some other method than receiving paper mail.

### SUMMARY OF THE INVENTION

The instant application discloses, among other things, techniques to allow a user to manage communications with direct mail senders, such as terminating the receipt of paper mail, requesting to receive information electronically, or optimizing the form and number of communications the user wishes to receive from a particular direct mail sender.

One embodiment may allow a user to take a photo of undesired mail, which may be processed via image recognition techniques to determine a sender of the undesired mail. The sender may be asked to stop sending such undesired mail to the user. It may also allow the user to request alternative forms of communication.

### BRIEF DESCRIPTION OF THE DRAWINGS

FIG. 1 is an example of a system capable of supporting Mail Management.

FIG. 2 is an example of an embodiment of Mail Management in which User Device takes a photograph of a Junk Mail.

FIG. 3 is a flowchart describing one embodiment of Mail Management.

FIG. 4 is a flowchart describing another embodiment of Mail Management.

FIG. 5 is a flowchart describing yet another embodiment of Mail Management.

FIG. 6 is a flowchart describing one embodiment of Image Recognition.

FIG. 7 is a flowchart showing one embodiment of some aspects of a mail management system from a user's perspective.

FIG. 8 illustrates features available in one embodiment of a mail management system.

FIG. 9 illustrates a component diagram of a computing device according to one embodiment.

### DETAILED DESCRIPTION

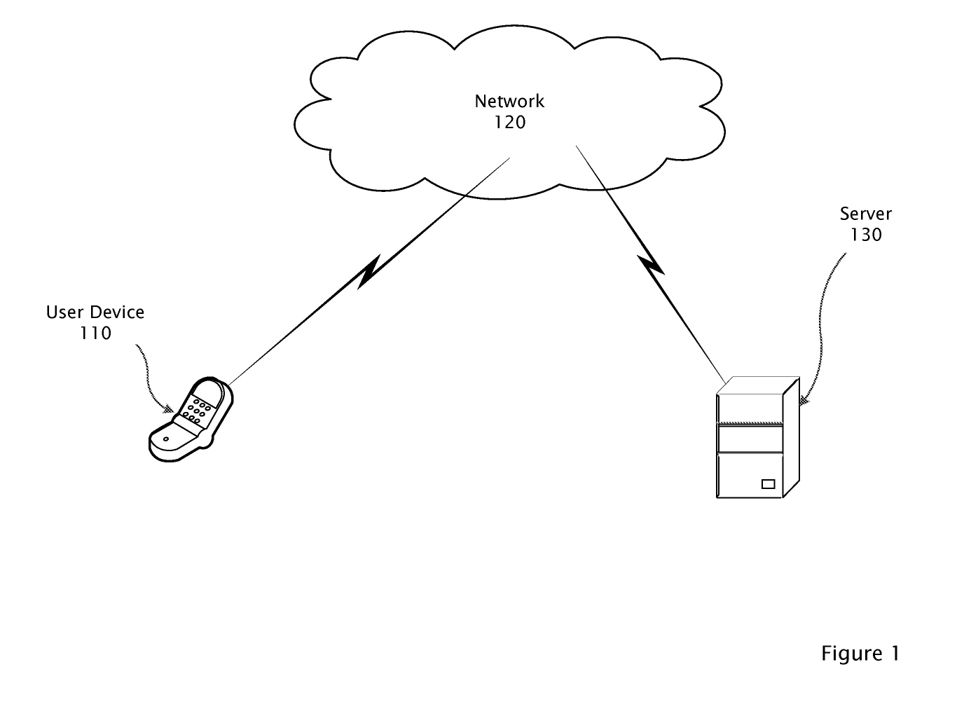

FIG. 1 is an example of one embodiment of a system capable of supporting Mail Management. In this example, User Device 110 may be used to originate a request for Mail Management and send it via Network 120 to Server 130. Network 120 may be a local area network, or it may include the Internet. Any type of communication link may work, or all processing may occur on one device.

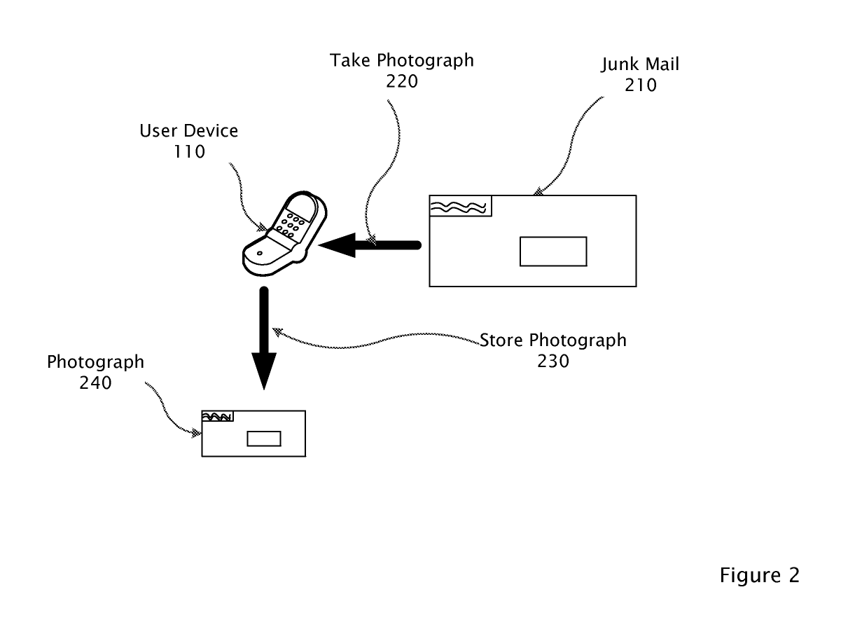

FIG. 2 is an example of an embodiment of Mail Management in which a user takes a Photograph 220 of a Junk Mail 210 from a sender using User Device 110. A Photograph 240 may be Stored 230. This may provide an image to provide to a process to allow the user to request the sender to stop sending Junk Mail 210. In another embodiment, a voice clip may be used instead of a picture. A user may record a name, title or some other means of identification of the Junk Mail 210, and submit the voice clip to a process to allow the user to request the sender to stop sending Junk Mail 210.

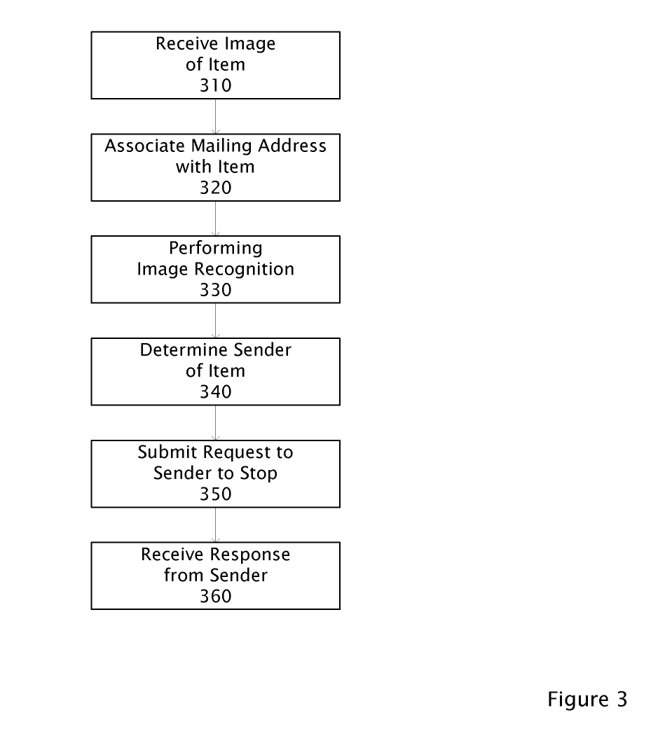

FIG. 3 is a flowchart describing one embodiment of Mail Management. In this embodiment, an Image of an Item may be received 310. This may be an existing image or a new photograph of a piece of Junk Mail 210. A Mailing Address may then be Associated with the Item 320. The Mailing Address may optionally be changeable, so that a user may manage mail for multiple addresses, such as home, work, other family members' addresses, or friends' addresses.

The Image may then be processed by Image Recognition 330, to Determine a Sender of the Item in the Image 340.

Submitting Request to Sender to Stop 350 may occur via various forms of communication channels, for example email, a request on a web page, a web service interface, a phone call, or postal mail. One of these or any other available communication channel may be used to submit a request to the sender once a Sender of Item is Determined 340.

Once the Sender has been Requested to Stop 350 further sending of Junk Mail 210, a Response may be Received from the Sender 360. The response may be provided in various ways, including, but not limited to, mail, email, an entry on a web site, or an application programming interface (API). This response may indicate that the request was successful, and they will stop sending Junk Mail 210 to the address for the request. If the request is not successful, a response may include a different contact point to submit such a request, or it may include an indication that the sender does not have the address on file. Other responses may also be received. If any non-successful result is received, additional steps may be used to obtain a successful result of stopping Junk Mail 210 from being sent.

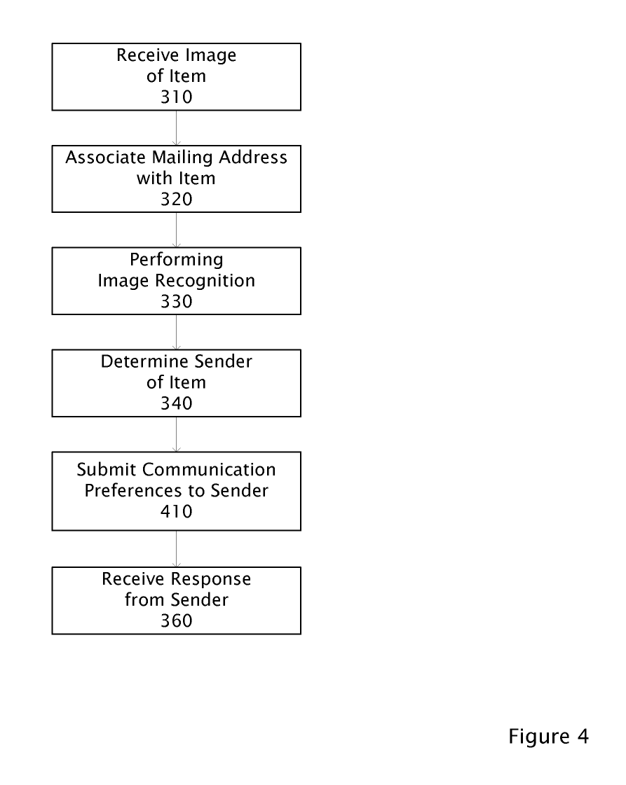

FIG. 4 is a flowchart describing another embodiment of Mail Management. In this embodiment, an Image of an Item may be Received 310, and Associated with a Mailing Address 320. Image Recognition may be Performed 330, and a Sender of the Item may be Determined 340.

Communication Preferences may be Submitted to the Sender 410, which may allow a user to prescribe the form and type of communication they wish to receive from the sender. By way of example and not limitation, a user may wish to continue receiving coupons electronically, via email or text message, for example, rather than receiving paper coupons in coupon packs received via postal mail. Another user may like to receive access to a catalog online, but not receive a printed one. But this user may still like to receive paper coupons in postal mail. Other users may wish to “Like” the sender's social media site like FACEBOOK, “follow” the sender on a social media site like TWITTER, friend the sender on one or more social media sites such as FACEBOOK or GOOGLE PLUS. By allowing a user to specify preferences to a sender, the sender may improve customer satisfaction, while improving efficiency compared to sending paper communications to users who do not wish to receive some forms of communications.

A Response may be Received from the Sender 360.

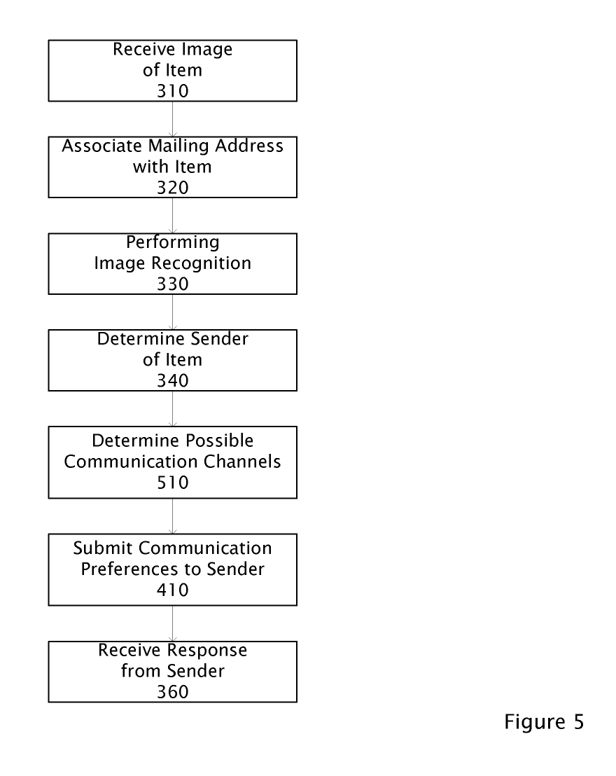

FIG. 5 is a flowchart describing yet another embodiment of Mail Management. This embodiment includes determining possible communication channels with which to communicate with a sender of an item of interest. Various communications channels may include one or more email addresses, web sites, telephone numbers, physical addresses, fax numbers, social media sites, or any other way to communicate with the sender. Once a channel has been found, communications preferences may be sent, further communication channels may be determined, or both communications preferences may be sent and further communication channels may be determined.

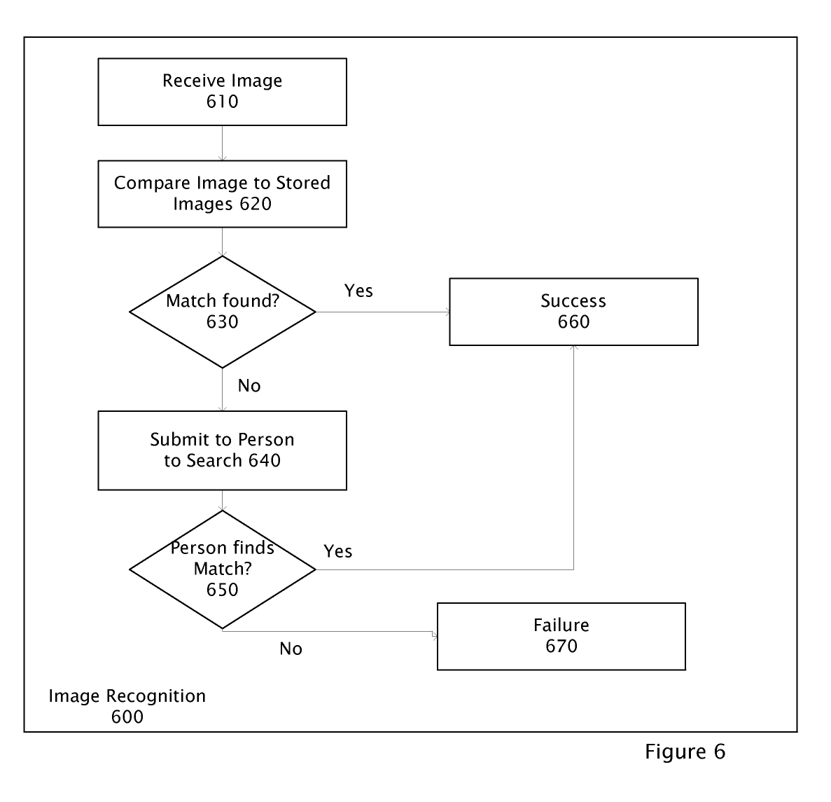

FIG. 6 is a flowchart describing one embodiment of Image Recognition. Image Recognition 600 may be done by machine using, for example, pattern matching software, optical character recognition, or may be performed by one or more people. By way of example and not limitation, an image database may be stored on a server. An Image Recognition 600 routine or module may Receive an Image 610 representing an item of interest, such as Junk Mail 210.

Received Image 610 may be Compared with Stored Images 620 in a database. If a Match is Found 630—Yes, Success 660 may be indicated. If a Match is Not Found 630—No, Image 610 may be Submitted to a Person to Search 640. The person may examine the Selected Image and use various techniques such as web searches, searches in a dedicated image database, personal knowledge, or any other means available to identify the source of the Received Image's 610 item of interest. In one embodiment, the source may provide information to aid in a search, for example a source may input information on a web site. If the Person finds a Match 650—Yes, Success 660 may be indicated. If a Match is Not Found 630—No, Failure 670 may be indicated.

One skilled in the art will recognize that other techniques of Image Recognition 600 may be used to identify items in an image, including but not limited to optical character recognition and pattern matching. By way of example, one or more of techniques may be used in combination with other similar or different approaches, with results selected by a voting system, such that if three systems are used and two agree on a source, that source may be indicated as a successful match. In another embodiment, three image recognition results may be obtained, and if they don't all agree, another result may be obtained to provide a result. Image Recognition 600 may be executed on a single device, such as, but not limited to, User Device 110, or spread across a plurality of devices, each of which may do processes in parallel or in series with one another. In one embodiment, one selection may be chosen from a plurality of potential matches for the image provided from a server. Such matching may be performed automatically, or a user may be provided with a list of potential matches from which to select. One skilled in the art will recognize that there may be many ways to implement image recognition within the scope of the instant disclosure.

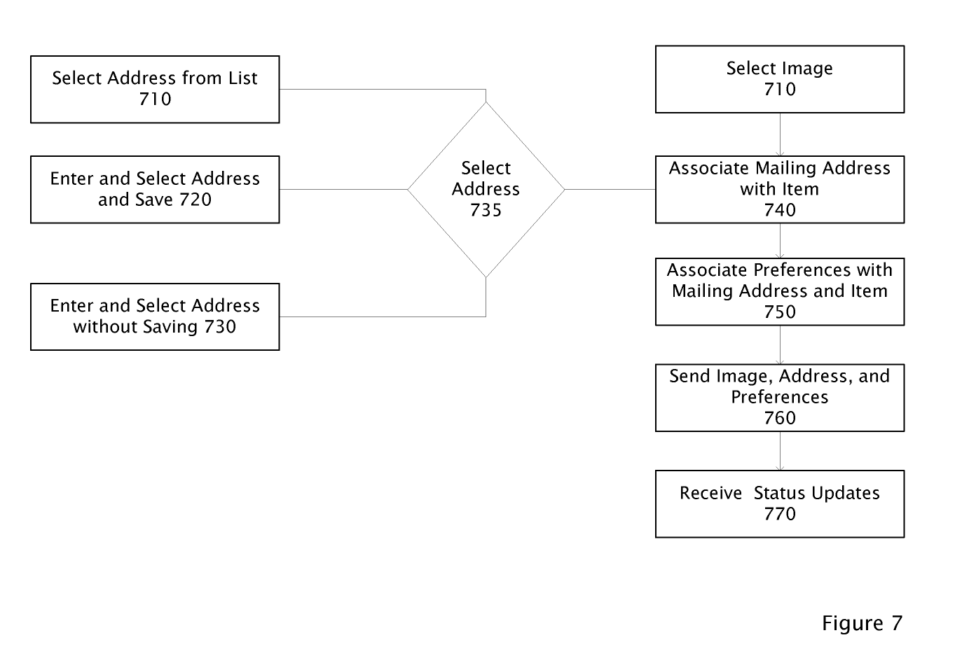

FIG. 7 is a flowchart showing one embodiment of some aspects of a mail management system from a user's perspective. A user may Select an Image 710 containing an item of interest. The user may then Associate a Mailing Address 740 with the item. Select Address 735 may be done in several ways. In this embodiment, the user may have a choice of Selecting an Address from a List 710, Entering an Address, Saving it to the List and Selecting it 720, or Entering and Selecting an Address without Saving it to the List 730. In another embodiment, an address may be obtained through the use of a GPS. One skilled in the art will realize that other ways of obtaining an address may also be used, and that addresses may be selected as mailing addresses, latitude and longitude, or any other identification scheme that may be used to determine a mailing address.

The user may also Associate Preferences 750 relating to a source of the Item and the Address. These preferences may include, for example, wishing to receive more mail, to receive less mail, to switch to electronic communication from that source, to obtain different types of communication (for example coupons instead of catalogs, weekly summaries rather than daily, or to receive or not receive calls from a representative), or to stop receiving communications from that source completely.

The user may send the Image, the Address, and the Preferences 760 to a mail management system. The mail management system may provide Status Updates which the user may then Receive 770.

Status Updates 770 may indicate that the request was successful, and the source will adjust to the preferences for the request. If the request is not successful, a response may include a different contact point to submit such a request, or it may include an indication that the sender does not have the address on file. Other responses may also be received. If any non-successful result is received, additional steps may be used to obtain a successful result.

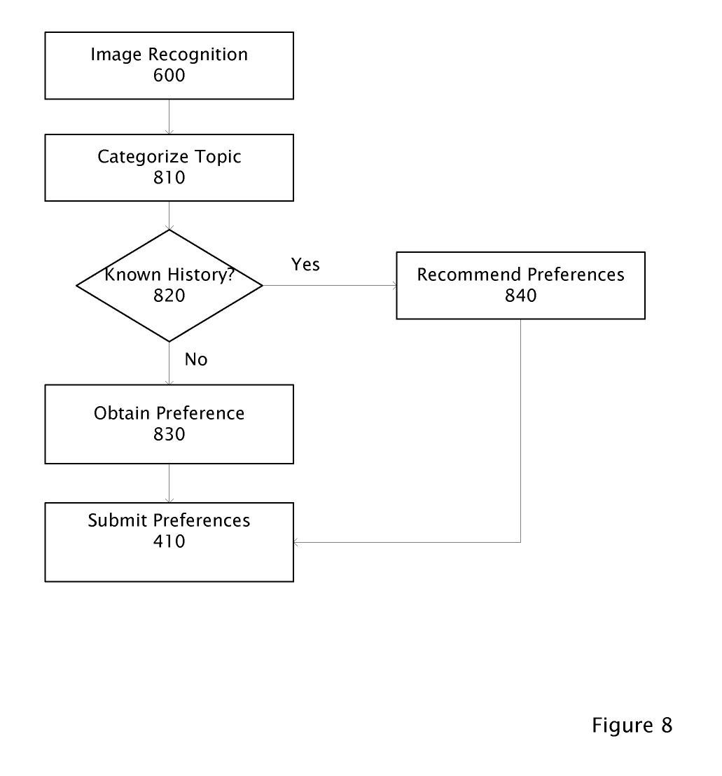

FIG. 8 illustrates features available in one embodiment of a mail management system. An image may be recognized, for example using Image Recognition 600. A topic for the recognized image may then be determined. Topics may be related to subject matter of the image. For example, if the image identifies a magazine related to SCUBA diving, a mail management system may Categorize Topic 810 as SCUBA diving. The Mail Management system may then check if there is a Known History 820 of preferences for SCUBA diving-related materials. If there is a Known History 820, the system may then use Recommended Preferences 840 based upon Known History 820. For example, if a user has generally selected preferences to obtain additional information about SCUBA diving, those preferences may be submitted, for example, in a process similar to that outlined in Submit Preferences 410. If there is no Known History 820, a preference may be obtained 830 from the user, and the obtained preference may be submitted 410.

Various algorithms may be used to provide Recommended Preferences 840, including but not limited to K-Nearest Neighbor, Pearson Correlation, or Rocchio Relevance Filtering. One skilled in the art will recognize that any one or any combination of such algorithms may be used.

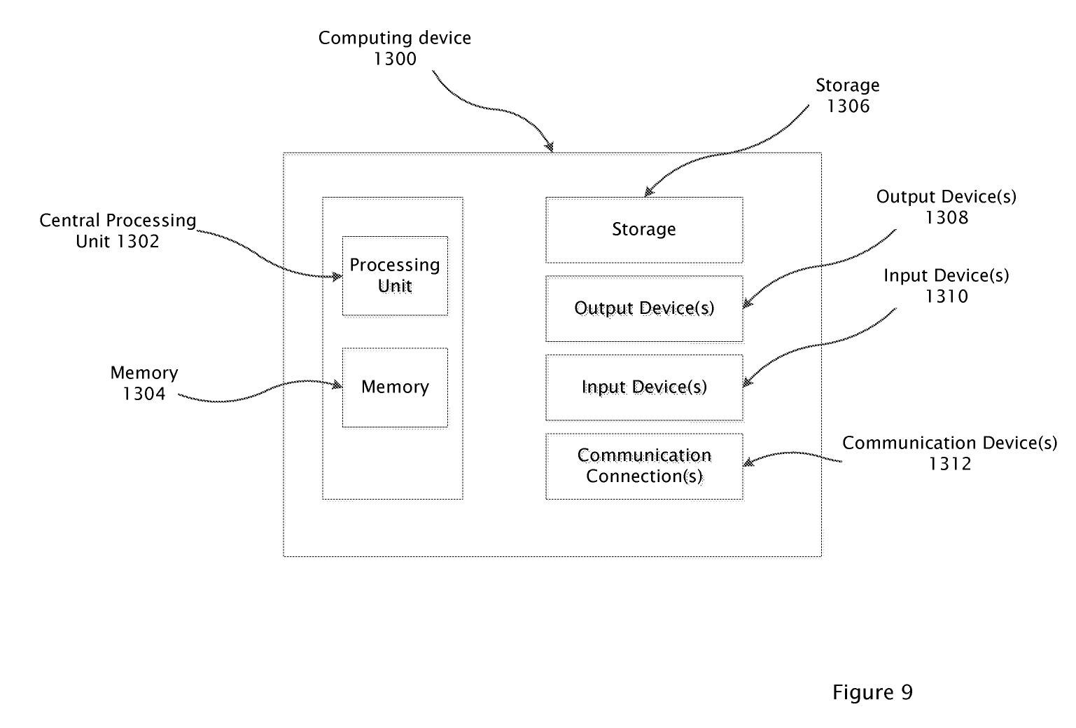

FIG. 9 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a Server (140) or a Client (150). The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 8 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1) A mail management system comprising:
a processor;
a memory coupled to the processor;
an identifier receiving component configured to allow receiving an identifier of an item of mail;
an identifier recognition component configured to perform recognition on the identifier to determine a sender of the item of mail;
a preference submission component configured to submit a preference request to the sender; and
a notification receiving component configured to receive a response resulting from the preference request.

2) The system of claim 1 further comprising a communication channel discovery component configured to find one or more channels with which to communicate with the sender.

3) The system of claim 1 wherein the perform recognition on the identifier comprises performing optical character recognition on an image.

4) The system of claim 1 wherein the perform recognition on the identifier comprises performing speech to text processing on a sound clip.

5) The system of claim 1 further comprising:
a topic characterizing component, configured to categorize a topic of the identifier; and
a recommending component, configured to recommend a preference.

6) A method comprising:
receiving an identifier of an item of mail;
associating the item of mail with an address;
performing recognition on the identifier to determine a sender of the item of mail; and
submitting via a first communication channel to the determined sender a preference request to inform the sender communication preferences for the address.

7) The method of claim 6 further comprising discovering available communications channels to determine the first communication channel.

8) The method of claim 6 wherein the associating the item of mail with an address further comprises selecting an address from a previously saved list of addresses.

9) The method of claim 6 wherein the associating the item of mail with an address further comprises entering an address to use.

10) The method of claim 6 wherein the associating the item of mail with an address further comprises identifying an address by using a GPS.

11) The method of claim 6 further comprising receiving a response from the determined sender containing information about the success of the request.

12) The method of claim 11 wherein the communication preferences comprise cessation of paper mail from the sender to the address.

13) The method of claim 11 wherein the communication preferences comprise a request for future communications to be performed electronically.

14) The method of claim 11 wherein the communication preferences comprise forming an association with a social media site associated with the sender.

15) The method of claim 11 further comprising resubmitting a request via a second communication channel to stop sending mail to the address if the response indicates the request was not successful.

16) A system comprising:
a processor;
a memory coupled to the processor;
an identifier selection component configured to allow selecting an identifier of an item of mail;
an associate address component configured to associate an address with the identifier;
an information submission component configured to submit information associated with an item, an address, and a preference to a mail management service; and
a notification receiving component configured to receive a status resulting from the preference request.

17) The system of claim 16 wherein the associate address component provides a way to select an address from a plurality of previously stored addresses.

18) The system of claim 17 wherein the information associated with an item comprises an image of the item.

19) The system of claim 18 wherein the information associated with an item comprises text obtained by analysis of the item.

20) The system of claim 17 wherein the information associated with an item comprises a sound clip identifying the item.
